(19) United States
(12) Patent Application Publication
(10) Pub. No.: US 2016/0107753 A1
(43) Pub. Date: Apr. 21, 2016

(54) SEAT FASTENING SYSTEM, SEAT OR SEAT GROUP, AIRCRAFT CABIN, AND METHOD FOR FASTENING A SEAT OR A SEAT GROUP

(71) Applicant: Airbus Defence and Space GmbH, Ottobrunn (DE)

(72) Inventors: Yavuz Toktas, Luneburg (DE); Patrick Rollfink, Hamburg (DE)

(21) Appl. No.: 14/884,116

(22) Filed: Oct. 15, 2015

(30) Foreign Application Priority Data
Oct. 17, 2014 (EP) 14 189 450.1

(51) Int. Cl. B64D 11/06; B64F 5/00

(52) U.S. Cl. CPC B64D 11/0696; B64F 5/0009

(57) ABSTRACT

In order to reduce weight, simplify the mounting of a seat or a seat group, and increase the flexibility in the cabin, a seat fastening system for a seat or a seat group of an aircraft comprises at least one mounting plate configured to attach the seat or the seat group to an aircraft structure of the aircraft, and at least one fastening module configured to fasten the seat or the seat group to the mounting plate.

### CROSS-REFERENCE TO RELATED APPLICATIONS

This application claims priority under 35 U.S.C. §119(a) to an European Patent Application No. 14 189 450.1 filed on Oct. 17, 2014, the entire contents of an European Patent Application No. 14 189 450.1 are hereby incorporated herein by reference.

### BACKGROUND

1. Field of the Invention

The present invention relates to a seat fastening system for a seat or a seat group of an aircraft, in particular, an airplane. The invention further relates to a seat or a seat group for an aircraft having at least one such seat fastening system. Furthermore, the invention relates to an aircraft cabin, in particular, an airplane cabin of an aircraft. Moreover, the invention relates to a method for fastening a seat or a seat group of an aircraft, in particular an airplane, to an aircraft structure by such a seat fastening system.

2. Background Information

Seats or seat groups, which are also designated as seat benches, of an aircraft, in particular an airplane, are fastened into the airplane cabin by seating rails integrated within the floor of the airplane cabin. The seating rails are provided with a locking mesh crown whose locking mesh comprises equidistant bores along the crown. The seats or seat groups are positioned via the locking mesh within the airplane cabin. For fastening the seats to the seat rails, fastening members are initially fastened to the legs of the seats or seat groups. The fastening members are a fitting assembly getting inserted into the locking mesh crown and are fastened therein by a locking mechanism disposed at the fastening member.

The previously known seat fastening systems, seats or seat groups, aircraft cabins and methods for fastening a seat or a seat group have the disadvantage that just a small portion of the seat rail is necessary for fastening so that unnecessary portions of the seat rails are a majority. This in turn causes weight which leads to an increased kerosene consumption. Due to the locking mesh crown the fastening members cant within the rail thereby causing complications and a time-consuming installation. Moreover, the flexibility is limited due to the rails in the airplane cabin. Furthermore, additional covers are needed for the unnecessary portions in order to protect the seat rails from environmental influences, such as liquids.

### SUMMARY

It is therefore an object of the invention to provide a seat fastening system, a seat or a seat group having such a seat fastening system, an aircraft cabin, as well as a method for fastening a seat or a seat group by such a seat fastening system, allowing for a reduced weight, a simplified mounting of a seat or seat group, and an increased flexibility of the cabin. This object can be achieved by the subject-matter of the claims.

According to a first aspect, the invention provides a seat fastening system for a seat or a seat group of an aircraft, in particular an airplane, comprising at least one mounting plate for attaching the seat or the seat group to an aircraft structure, in particular an aircraft cabin, of the aircraft and at least one fastening module for fastening the seat or the seat group to the mounting plate. By using the seat fastening system according to the invention, new materials and construction methods can be employed, thereby causing a reduction in weight. Moreover, it is possible to exchange single mounting plates having a defect, thereby increasing maintainability. Also, the seat fastening system according to the invention allows a simple and fast mounting of a seat or seat group. Furthermore, the seat fastening system according to the invention is easy to maintain and allows a clear definition of load paths.

It is preferred that the at least one mounting plate is configured as a floor plate of the aircraft structure, in particular the aircraft cabin. Consequently, the seating system according to the invention can be integrated within the floor of the aircraft cabin. Thus, an optimization of the floor structure of the aircraft cabin and the use of innovative materials is possible.

It is preferred that the mounting plate includes at least one attachment junction for fastening the fastening module. The attachment junction allows for a simple and fast mounting of the fastening module to be effected. The attachment junction can be configured as a hole or stud hole with a thread for fastening the fastening module. It is preferred that the mounting plate comprises multiple attachment junctions for fastening the fastening module, wherein the attachment junctions form a row of holes. Additionally advantageous, the mounting plate comprises multiple attachment junctions for fastening the fastening module, wherein the attachment junctions form multiple parallel rows of holes.

It is preferred that the seat fastening system includes multiple mounting plates, wherein the mounting plates comprise multiple attachment junctions for fastening the fastening module, wherein the attachment junctions form multiple parallel rows of holes. Attachment junctions not in use can be covered using standardized covers. It is preferred that the at least one attachment junction comprises an attachment unit connected to the mounting plate. Advantageously, each of the attachment junctions comprises an attachment unit connected to the mounting plate.

It is preferred that the attachment unit includes an accommodating opening and a thread. The fastening module can be detachably connected to the mounting plate via the thread. Presently, the attachment unit is also designated as insert.

In an advantageous embodiment the accommodating opening serves for inserting a centering bolt acting as a form-fitting interface between the seat or the seat group and the mounting plate. In another advantageous embodiment the fastening module includes at least one seat fastening member for fastening the seat and at least one fastening member for fastening the seat fastening member to the mounting plate.

It is preferred that the seat fastening member is configured as a fastening rail for fastening the seat or the seat group to the mounting plate. Advantageously, the fastening rail is fastened to one or multiple mounting plates by two fastening members, as preferably two fastening members are screwed into an attachment junction, respectively, in particular into a thread of the attachment unit.

Moreover advantageous, the fastening rail includes a through-opening for inserting the at least one fastening member. The fastening member can be connected to the attachment junction, in particular to the thread of the attachment unit, via the through-opening.

It is preferred that the seat fastening member includes at least one fastening section for fastening at least one seat leg of the seat or of the seat group. Advantageously, the seat fastening member includes, at each end portion respectively, a fastening section for fastening one leg of the seat or of the seat group. The seat or the seat group can be connected to the fastening section via a bolt connection.

Advantageously, the fastening section is configured as a flange section protruding from the fastening rail, the flange section having a through-opening for feeding through a bolt. Preferably, the through-opening is configured as a slot.

It is preferred that the seat fastening member includes a row of holes associated with the mounting plate, when the seat fastening member is in a fastened state. The row of holes can serve as an accommodation for a section of a centering member protruding from the attachment unit.

It is preferred that the fastening member comprises a screw and a washer. Advantageously the screw is configured as a tension screw.

It is preferred that the fastening module includes at least one centering member. A form-fitting connection of the seat and the seat group with the at least one mounting plate is effected by the centering member. The centering members can be inserted into the accommodating opening of the attachment units. Advantageously, a section which is accommodatable by the row of holes of the fastening rail protrudes from the accommodating opening of the attachment unit.

Advantageously, the centering member is configured as a centering bolt. The seat or seat group can be aligned by the centering member, and it additionally transfers forces in the horizontal plane, in particular in x- and y-direction.

It is preferred that the mounting plate is made of fiber-reinforced plastic. Using fiber-reinforced plastic, the seat fastening system according to the invention has a lower weight.

It is preferred that the at least one attachment unit is made of metal. Preferably, the attachment unit is made of titanium. The attachment units are inserted into the plates by so called insert-technology. Here, the attachment units are inlayed into the tool form and encased with the fiber-reinforced plastic so as to result in a form-fitting connection between the fiber-reinforced plastic and the attachment units. Attachment units made of metal have a lower tendency to creep compared to a plastic part, so as to provide for a constant strong fastening of the fastening module, in particular the fastening members in the threads of the attachment units, for a long period.

According to a further aspect, the invention provides a seat or seat group for an aircraft, in particular an airplane, comprising at least one seat fastening system according to one or multiple of the previously described configurations. According to another aspect, the invention provides an aircraft cabin of an aircraft, in particular an airplane, comprising at least one mounting plate of a seat fastening system according to one or multiple of the previously described configurations.

According to a further aspect, the invention provides a method for fastening a seat or a seat group of an aircraft to an airplane structure, in particular an aircraft cabin, by a seat fastening system, having the following steps. First, at least one mounting plate comprising at least one attachment unit connected thereto, the attachment unit including an accommodating opening and a thread, and a fastening module that includes at least one centering member, at least one fastening member, and at least one seat fastening member having a slot for inserting the fastening member is provided. Then, the centering member is inserted into the accommodating opening of the attachment unit. Subsequently, the seat fastening member is positioned so as to allow the fastening member to be screwed into the thread of the attachment unit via the slot. The fastening member is then inserted into the slot and screwed into the thread. Finally, the seat or the seat group is fastened to the seat fastening member. Preferably, two fastening members are used for each seat fastening member, wherein each fastening member is connected to an attachment unit provided with a centering member, respectively.

It is preferred that the seat fastening member includes a fastening section for fastening the seat or the seat group, wherein the seat or the seat group are getting connected to the fastening section via a bolt connection. Advantageously, the seat fastening member includes two fastening sections, wherein the front leg of the seat or the seat group is getting connected to a first fastening section by a bolt connection and the rear leg of the seat or seat group is getting connected to a second fastening section by a bolt connection.

### DESCRIPTION OF THE DRAWINGS

Embodiments of the invention are explained in more detail in accordance with the accompanying drawings, in which:

FIG. 1 schematically depicts a seat group of an aircraft, in particular an airplane, with a seat fastening system according to an embodiment of the invention;

FIG. 2 schematically depicts an enlarged perspective view of the seat fastening system according to the invention of FIG. 1;

FIG. 3 schematically depicts an enlarged partial cross-section of a mounting plate in the area of an attachment unit of FIG. 1;

FIG. 4 schematically depicts an enlarged illustration of a fastening rail of the seat fastening system according to an embodiment of the invention;

FIG. 5 schematically depicts an enlarged bottom view of the fastening rail of FIG. 4;

FIG. 6 schematically depicts an enlarged illustration of a longitudinal section of the centering member of the seat fastening system according to an embodiment of the invention;

FIG. 7 schematically depicts a perspective illustration of mounting plates with attachment junctions of the seat fastening system according to the invention and centering bolts partially inserted into the attachment units;

FIG. 8 schematically depicts a perspective view of fastening rails disposed on the mounting plates in the area of the centering bolts;

FIG. 9 schematically depicts a perspective view of the fastening rails and the mounting plates, wherein the mounting plates are connected to the attachment units of the mounting plates by screws; and

FIG. 10 schematically depicts a perspective illustration of the fastening of the legs of the seat group to the fastening rail.

### DETAILED DESCRIPTION OF EMBODIMENTS

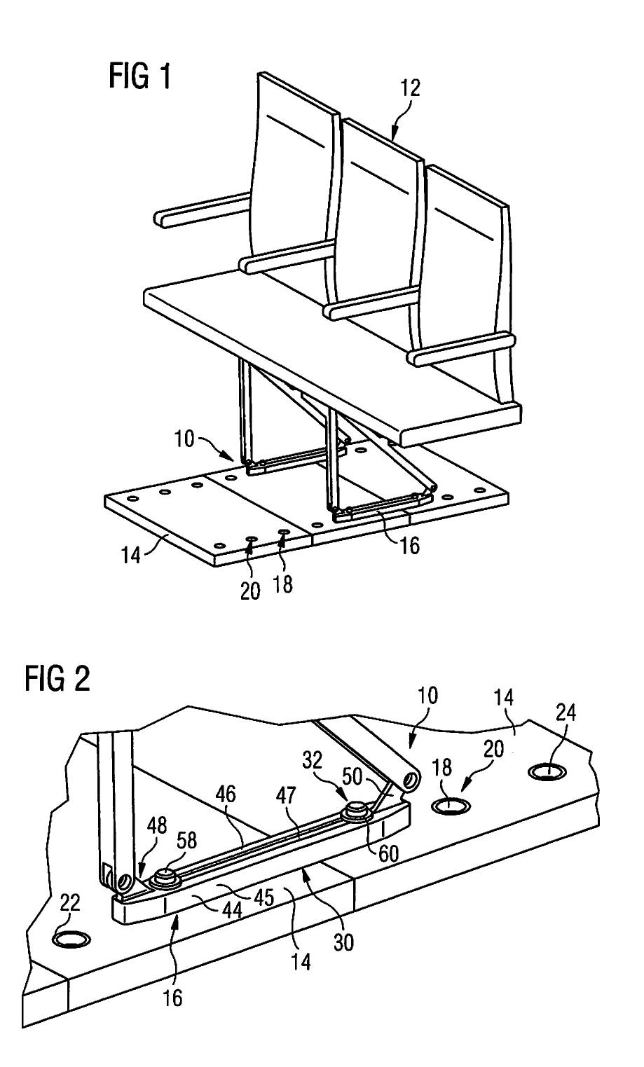

FIGS. 1, 2, and 10 illustrate a seat fastening system 10 for fastening a seat or a seat group 12 of an aircraft, in particular an airplane, to an airplane structure, in particular to an aircraft cabin. The seat fastening system 10 includes multiple rectangular shaped mounting plates 14 being in contact on the longitudinal sides, and fastening module 16, in particular two fastening modules 16 per seat or seat group 12, for fastening the seat group 12 to a mounting plate 14.

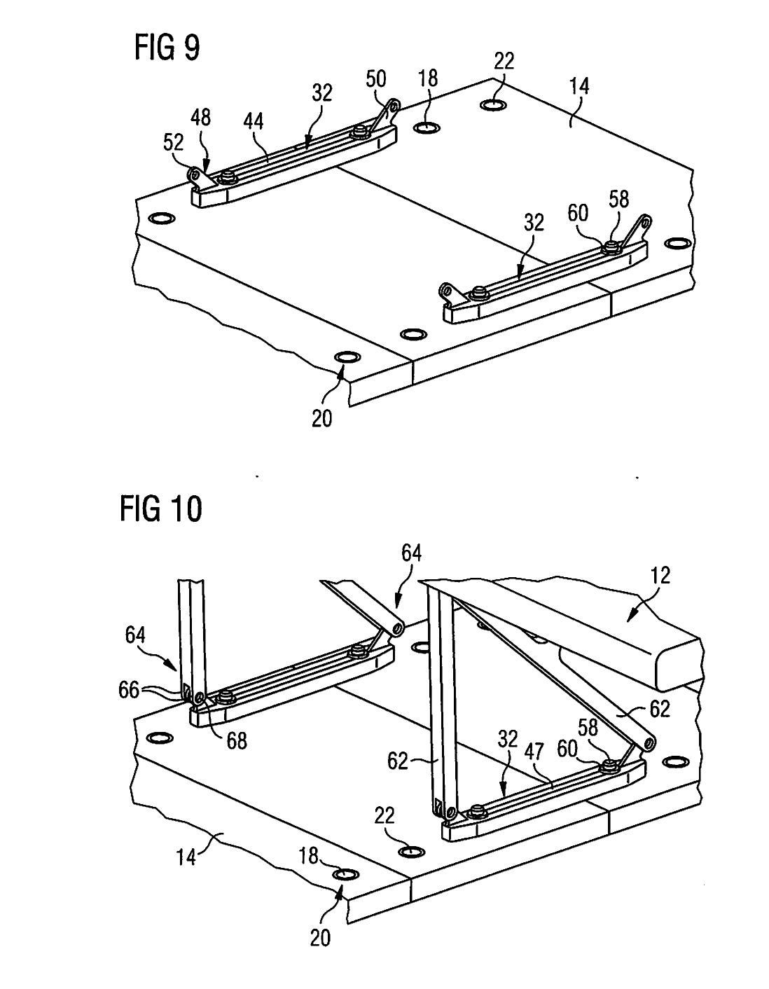

As particularly shown in FIGS. 1, 2, and 7 to 10, each of the mounting plates 14 includes multiple attachment junctions 18 for fastening the fastening modules 16. The attachment junctions 18 form two parallel rows of holes 20 on each mounting plate 14, wherein each row of holes 20 is formed by three attachment junctions 18. The mounting plates 14 are made of fiber-reinforced plastic.

Each of the attachment junctions 18 is formed by an attachment unit 22, also designated as insert or inlay, as particularly shown in FIG. 3. Presently, the attachment unit 22 is made of metal, in particular titanium. The attachment units 22 are form-fittingly connected to the mounting plate 14 by the so-called insert-technology. The attachment unit 22 includes an accommodating opening 24 and a thread 26 for screwing in a fastening member, in particular a screw. The fastening module 16 includes two centering members 28, a seat fastening member 30, and two fastening members 32.

As particularly shown in FIG. 6, the centering member 30 is configured as a centering bolt 34. The centering bolt 34 is insertable into the accommodating opening 24 of the attachment unit 22, wherein in the inserted state a section of the centering bolt 34 protrudes from the accommodating opening 24, as shown in FIG. 8. The centering bolt 34 includes a through-opening 36 for feeding through the fastening member 32. The through-opening 36 is formed by three sections, wherein a first and a second section 38, 40 have the same diameter and are connected together via a third section 42 having a smaller diameter than both the other sections 38, 40.

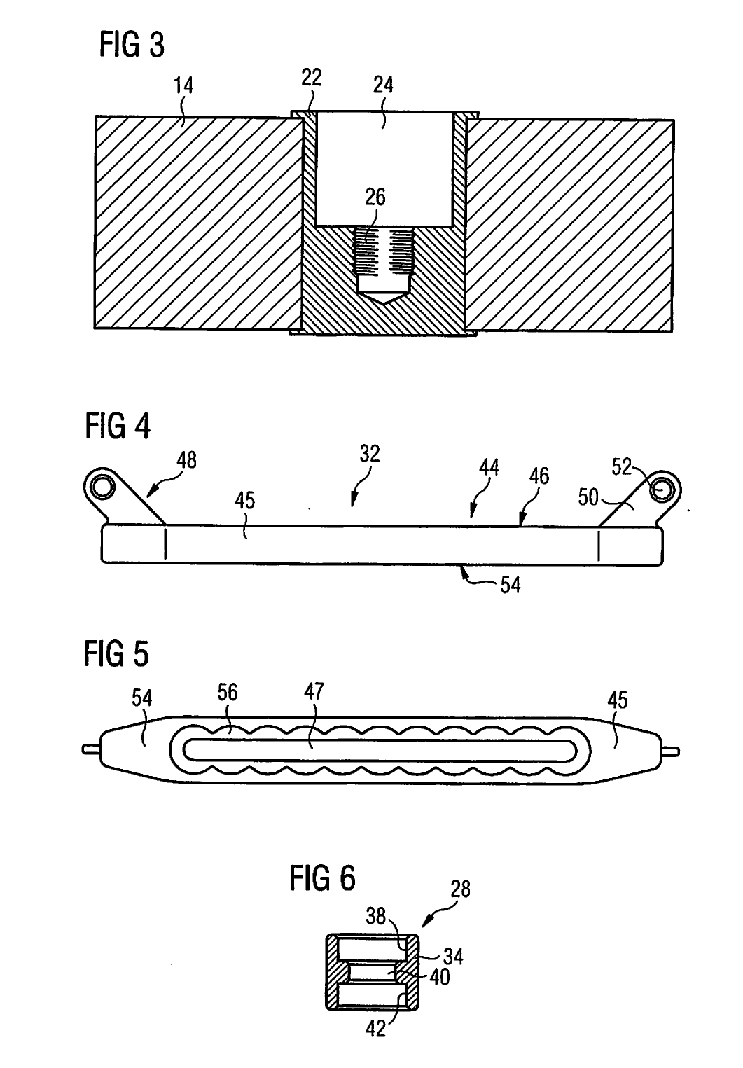

The seat fastening member 30 is configured as a fastening rail 44 which is also designated as bar. The fastening rail 44 includes an elongated base body 45. The base body 45 comprises, on an upper side 46, a slot 47 extending in longitudinal direction for feeding through the fastening members 32. Furthermore, the fastening rail 44 includes a fastening section 48 at respective end portions. The fastening section 48 is configured as a plate 50 protruding from the fastening rail 44, and having provided on its end portion an opening 52 for feeding through a bolt (not shown), as is shown in FIG. 4.

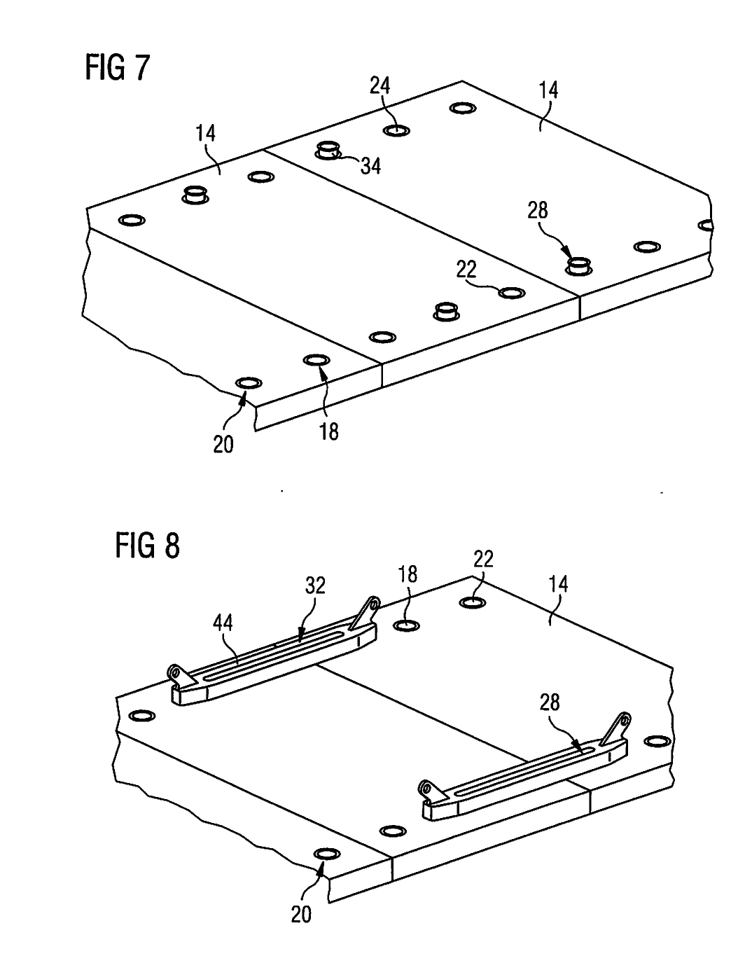

As shown in FIG. 5, the base body 45 includes on a bottom side 54 a row of holes 56 serving to accommodate the section of the centering bolt 34 which is protruding from the accommodating opening 24. In the following, a method for fastening a seat group 12 by the seat fastening system 10 is described, referring to FIGS. 7 to 10.

As shown in FIG. 7, initially, the mounting plates 14 are provided. The mounting plates 14 can be configured as floor plates of the aircraft cabin and be installed therein. Subsequently, the centering bolts 34 are inserted into the accommodating openings 24 of the attachment units 22. Here, for each fastening rail 44, two centering bolts 34 are used wherein, in order to achieve a better load distribution, both the centering bolts 34 are spaced apart by an unequipped attachment unit 22. Subsequently, for each row of holes 20, a fastening rail 44 is put on the protruding sections of the centering bolts 34, respectively. Hereafter, the tension screws 58 are provided with washers 60 and inserted via the slot 47 into the centering bolts 34 and are screwed into the thread 26. Finally, the legs 62 of the seat group 12 are connected to the fastening sections 48 of the fastening rail 44 via a bolt connection not shown. For this, the legs 62 include an accommodating section 64 at an end portion for accommodating a fastening section 48. The accommodating section 64 is formed by two limbs 66 spaced apart from each other, wherein the fastening section 48 and the plate 50 are accommodated therebetween, respectively. Each of the fastening limbs 66 includes a through-opening 68. The fastening limbs 66 are positioned in such a way that the through openings 68 are coaxially aligned to the openings 52 so as to allow feeding through a bolt, which is not shown, for fastening.

What is claimed is:

1. A seat fastening system for a seat or a seat group of an aircraft comprising:
at least one mounting plate configured to attach the seat or the seat group to an aircraft structure of the aircraft; and
at least one fastening module configured to fasten the seat or the seat group to the mounting plate.

2. The seat fastening system according to claim 1, wherein
the mounting plate includes at least one of the following:
at least one attachment junction configured to fasten the fastening module;
multiple attachment junctions configured to fasten the fastening module and form a row of holes; and
multiple attachment junctions configured to fasten the fastening module and form multiple parallel rows of holes; and
the seat fastening system includes multiple mounting plates comprising multiple attachment junctions that are configured to fasten the fastening module and form multiple parallel rows of holes.

3. The seat fastening system according to claim 2, wherein at least one of the following
the at least one attachment junction comprises an attachment unit connected to the mounting plate;
each of the attachment junctions comprises an attachment unit connected to the mounting plate; and
the attachment unit includes an accommodating opening and a thread.

4. The seat fastening system according to claim 1, wherein
the fastening module includes at least one seat fastening member configured to fasten the seat and at least one fastening member configured to fasten the seat fastening member to the mounting plate.

5. The seat fastening system according to claim 4, wherein
the seat fastening member is configured as a fastening rail to fasten the seat or the seat group to the mounting plate, and the fastening rail includes a through-opening configured to accommodate the at least one fastening member.

6. The seat fastening system according to claim 4, wherein
the seat fastening member includes at least one fastening section configured to fasten at least one leg of the seat or of the seat group.

7. The seat fastening system according to claim 4, wherein
the seat fastening member includes a row of holes associated with the mounting plate when the seat fastening member is in a fastened state.

8. The seat fastening system according to claim 4, wherein
the fastening member comprises a screw and a washer.

9. The seat fastening system according to claim 1, wherein
the fastening module includes at least one centering member.

10. The seat fastening system according to claim 1, wherein
the at least one mounting plate is made of fiber-reinforced plastic.

11. The seat fastening system according to claim 3, wherein
the at least one attachment unit is made of metal.

12. The seat or seat group for an aircraft comprising at least one seat fastening system according to claim 1.

13. An aircraft cabin of an aircraft comprising at least one mounting plate of a seat fastening system according to claim 1.

14. The seat fastening system according to claim 2, wherein
the fastening module includes at least one seat fastening member configured to fasten the seat and at least one fastening member configured to fasten the seat fastening member to the mounting plate.

15. The seat fastening system according to claim 3, wherein
the fastening module includes at least one seat fastening member configured to fasten the seat and at least one fastening member configured to fasten the seat fastening member to the mounting plate.

16. The seat fastening system according to claim 5, wherein
the seat fastening member includes at least one fastening section configured to fasten at least one leg of the seat or of the seat group.

17. The seat fastening system according to claim 5, wherein
the seat fastening member includes a row of holes associated with the mounting plate when the seat fastening member is in a fastened state.

18. The seat fastening system according to claim 6, wherein
the seat fastening member includes a row of holes associated with the mounting plate when the seat fastening member is in a fastened state.

19. A method for fastening a seat or a seat group of an aircraft to an airplane structure by a seat fastening system, comprising:
providing at least one mounting plate comprising at least one attachment unit connected thereto, the attachment unit including an accommodating opening, a thread and a fastening module, the fastening module including at least one centering member, at least one fastening member, and at least one seat fastening member having a through-opening configured to receive the fastening member;
inserting the centering member into the accommodating opening of the attachment unit;
positioning the seat fastening member to allow the fastening member to screw into the thread of the attachment unit via the slot;
inserting the fastening member into the slot and screwing in the fastening member into the thread; and
fastening the seat or the seat group to the seat fastening member.

20. The method according to claim 19, wherein
the seat fastening member includes a fastening section configured to fasten the seat or the seat group, with the seat or the seat group connecting to the fastening section via a bolt connection.
